(19) United States
(12) Patent Application Publication
(10) Pub. No.: US 2005/0047898 A1
(43) Pub. Date: Mar. 3, 2005

(54) Linkage support system for a work vehicle

(75) Inventors: David Dennis Latham, Dubuque, IA (US); David Michael O'Brien, Dubuque, IA (US); Gregory Keith Werner, Durango, IA (US); John William Carruthers, Coal Valley, IL (US); John Mason Holmes, Colona, IL (US); Thomas Kevin Roller, Moline, IL (US)

Correspondence Address: Hope W. Carter;Patent Department, DEERE & COMPANY, One John Deere Place, Moline, IL, 61265-8098, US

(73) Assignee: Deere & Company, a Delaware corporation

(21) Appl. No.: 10/648,014

(22) Filed: Aug. 26, 2003

(51) Int. Cl. B66F 9/00

(52) U.S. Cl. 414/685

(57) ABSTRACT

A linkage support system and method for mounting and supporting a linkage on a work vehicle. The linkage support system includes a load bearing support and a removable linkage pin support rigidly attached to the load bearing support. The work vehicle is, typically, an earthmoving vehicle which includes a frame, a work tool such as a bucket, and a linkage for manipulating the work tool. The load bearing support may be a portion of the frame of the vehicle.

### FIELD OF THE INVENTION

The invention relates to supports for linkages for manipulating work tools such as, for example, buckets on loaders and other work vehicles. More specifically, it relates to a system and method of attaching the linkages to work vehicles.

### BACKGROUND OF THE INVENTION

On many work vehicles such as, for example, loaders, the mechanical performance of the linkage mechanism for manipulating a work tool, such as a bucket, is optimized, in part by the anchor position of the linkage on the frame, i.e., linkage pin location. It is sometimes difficult to gain the necessary optimal linkage pin location on the conventional frames on which these linkages are attached as the required locations may not be conducive to ease of frame manufacture.

### SUMMARY OF THE INVENTION

In order to gain a desired or optimal performance from a linkage mechanism of a work vehicle it is sometimes necessary to place linkage pin supports in positions that are less than optimal with respect to the manufacturing process for a conventional frame. This, can lead to undesirable increases in the time and cost for manufacture of the frame with less than optimal linkage performance. Additionally, during the life of the work vehicle, there may be occasions when an alternate linkage pin location may be desired for optimal performance of the same or of a different linkage. With conventional vehicles, such a change would require another frame or another vehicle either of which would significantly increase costs.

The inventors recognize that the problems above have resulted from the use of conventional one-piece frames which include the linkage pin supports and have solved the above problems by providing a removable linkage pin support. This arrangement makes it possible to achieve optimal linkage performance without the concomitant increases in the time and cost for manufacture associated with conventional frames. The invention replaces the complex linkage pin support area of the conventional frame with a linkage pin support system which includes a removable linkage pin support and a load support area of the frame suitable for the rigid attachment of the removable linkage pin support to the frame. In practice, the frame and the removable linkage pin support are separately manufactured and, afterwards, rigidly assembled using attaching bolts or some other suitable method of attachment.

During the life of the work vehicle conditions may arise where changes in linkage pin support locations are desirable such as, for example, a change in terrain or a desire to use a linkage of a different configuration. As noted earlier, the costs for such a change on a work vehicle with a conventional frame would be substantial as a change of vehicle or, at the least, a change of frame would be required. The invention makes it possible to modify linkage pin locations on a work vehicle without incurring the associated time and cost difficulties of replacing the entire frame or vehicle as the removable linkage pin support may be replaced by another removable linkage pin support of a different configuration.

### BRIEF DESCRIPTION OF THE DRAWINGS

Embodiments of the invention will be described in detail, with reference to the following figures, wherein:

FIG. 1 is a view of a work vehicle in which the invention may be used;

FIG. 2. is a view of an exemplary embodiment of a front portion of the work vehicle illustrated in FIG. 1;

FIG. 3 is a view of an exemplary embodiment of a removable linkage pin support from the front frame illustrated in FIG. 2;

FIG. 4 is a view of an exemplary embodiment of the removable linkage pin support of FIG. 3 with associated linkage pins assembled in place;

FIG. 5 is a detailed view of the front frame illustrated in FIG. 2 showing load bearing areas having a hole pattern that matches that of the removable linkage pin support shown in FIG. 4;

FIG. 6 is an exploded view of the exemplary embodiment of the front frame, the removable linkage pin support, and other associated parts illustrated in FIG. 2; and

FIG. 7 is a detailed sectional view of attachment hole 121b shown in FIG. 6.

### DETAILED DESCRIPTION

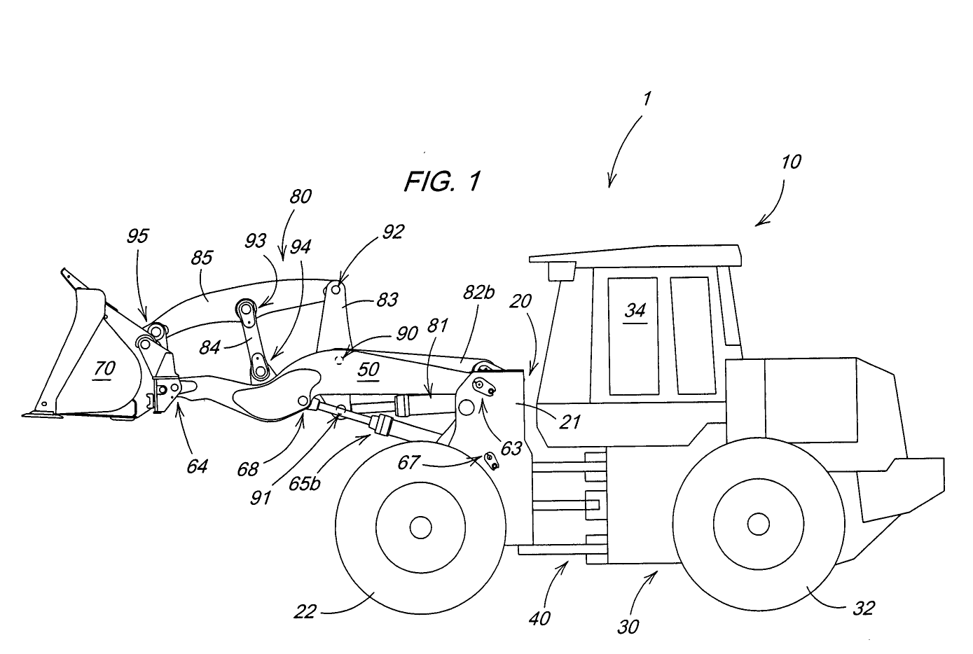

FIG. 1 illustrates a work vehicle in which the invention may be used. The particular work vehicle illustrated in FIG. 1 is an articulated four wheel drive loader having a main frame or body 10 that includes a front frame 20 pivotally connected to a rear frame 30 by vertical pivots 40, the loader being steered by pivoting of the front frame 20 relative to the rear frame 30 in a manner well known in the art. The front and rear frames 20 and 30 are respectively supported on front drive wheels 22 and rear drive wheels 32. An operator's station 34 is provided on the rear frame 30 and is generally located above the vertical pivots 40. The front frame 20 includes a mast 21 having a right mast portion 21a and a left mast portion 21b. The front and rear drive wheels 22 and 32 propel the vehicle along the ground and are powered in a manner well known in the art.

Mounted on the front frame 20 is a boom 50 that is partly formed by right and left arms 50a and 50b respectively. The right and left arms 50a and 50b are connected by a transverse cross tube 52 that is welded to each of the right arm 50a and the left arm 50b. The rear end of the boom 50 is connected to the mast 21 by transverse pivots 61 and 63 and a loader bucket 70 is mounted on the forward end of the boom 50 by transverse pivots 62 and 64. The boom 50 is rotated about transverse pivots 61 and 63 by hydraulic lift cylinders 65a and 65b, first ends of which are, respectively, connected to the front frame 20 at transverse pivots 65 and 67. Second ends of hydraulic lift cylinders 65a and 65b are, respectively, connected to the right and left arms 50a and 50b at transverse pivots 66 and 68.

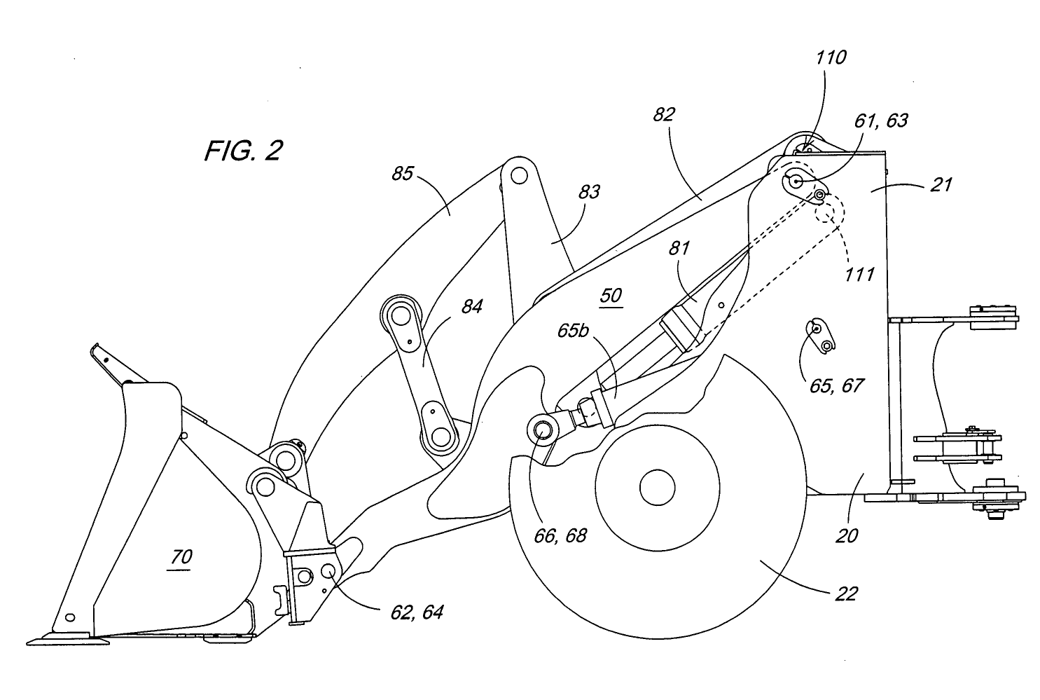

The rotational location of the bucket 70 about the pivots 62 and 64 is controlled by a linkage 80 which, in this particular configuration, includes: a hydraulic tilt cylinder 81; left and right leveling links 82a and 82b; a bell crank 83, a guide link 84; and a bucket link 85. The hydraulic tilt cylinder 81 powers the linkage 80 and is connected to the bucket by the bell crank 83 which is mounted on a transverse pivot 90 at the front end of the leveling links 82a and 82b. The hydraulic tilt cylinder 81 is connected to a first end of the bell crank 83 by a transverse pivot 91 and a second end of the bell crank 83 is connected to a first end of the bucket link 85 by a transverse pivot 92. The bucket link 85 is mounted on a transverse pivot 93 at a second end of the guide link 84 and a first end of the guide link 84 is connected to the cross tube 52 via a transverse pivot 94 carried in a support 54 welded to the cross tube 52. A second end of the bucket link 85 is pivotally connected to the loader bucket 70 via a transverse pivot 95. As shown in FIG. 2, a first end of the entire linkage 80, including the first end of the hydraulic tilt cylinder 81 and the first end of the leveling links 82a and 82b, is operatively mounted to a removable linkage pin support 100 via linkage pins 110 and 111. The removable linkage pin support 100 is rigidly connected to the front frame 20 at load bearing areas 120 and 122, which are portions of the mast 21, via bolts 130a and 130b. Linkage pins 110 and 111 are attached to the linkage pin support 100 via screws 103a and attachment holes 103 and 106.

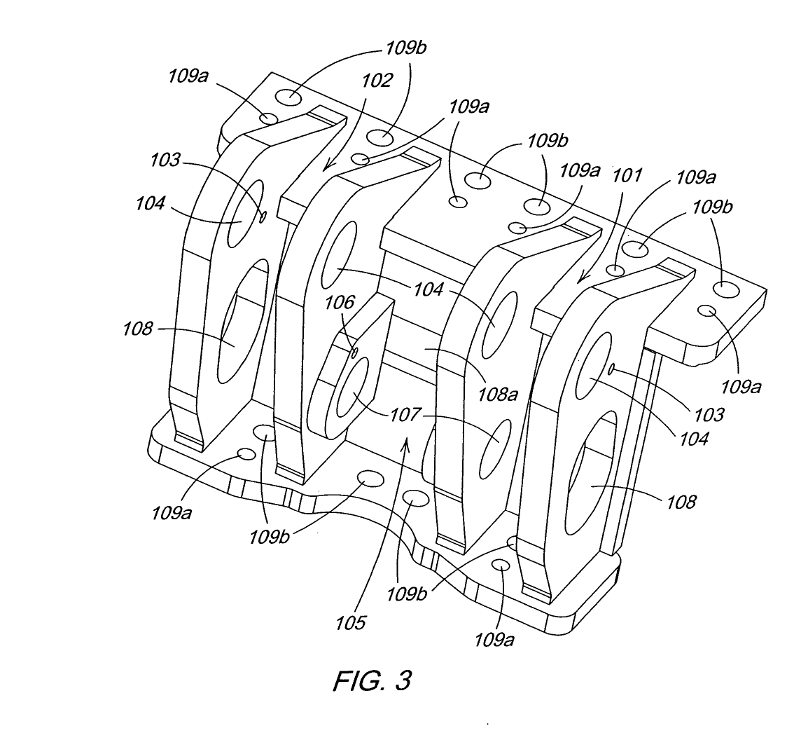

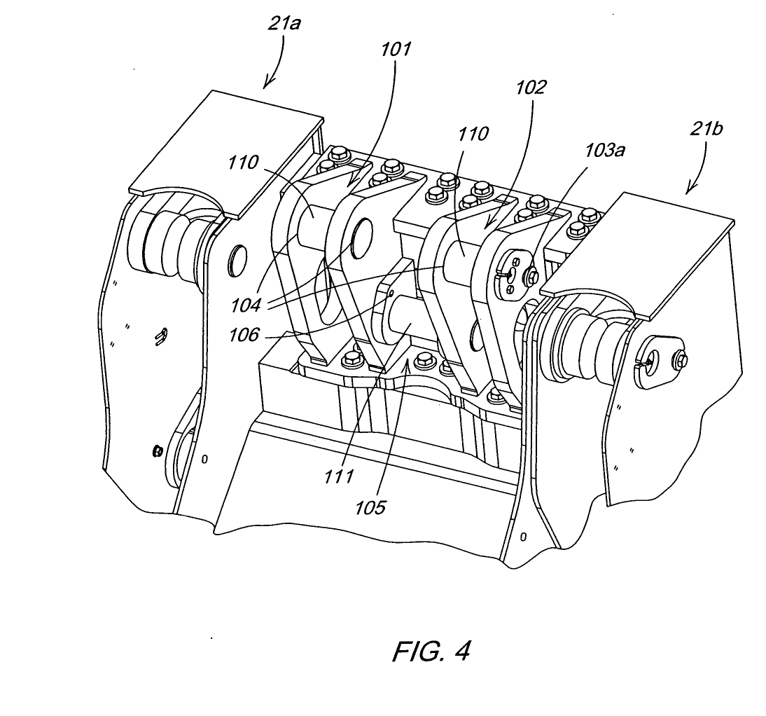

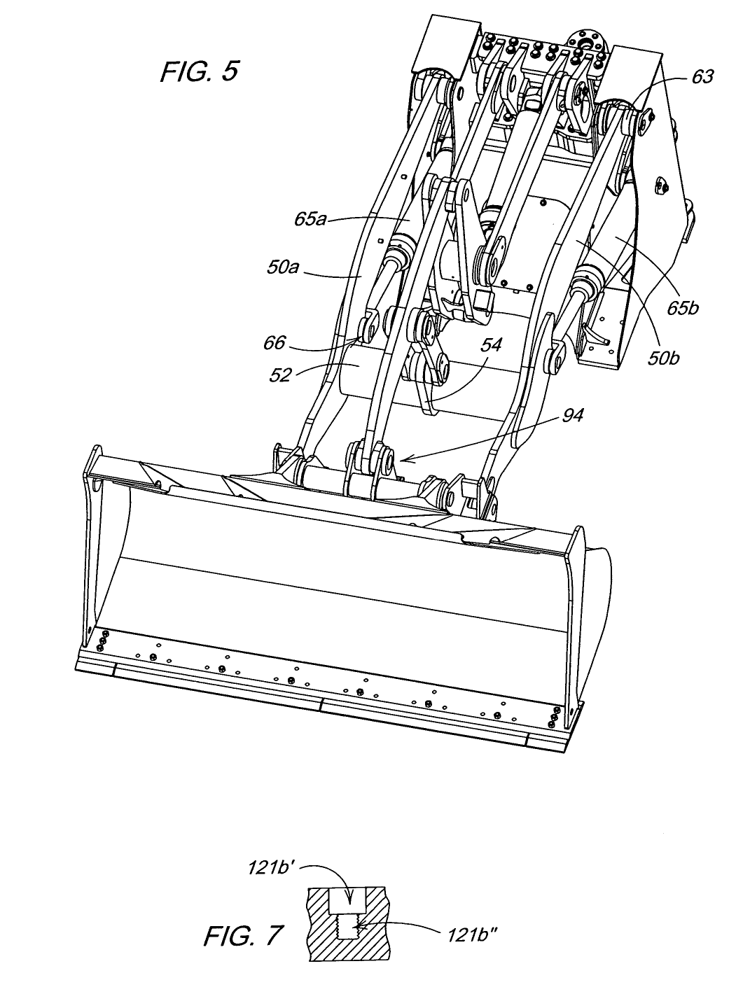

FIG. 3 is a detailed view of the removable linkage pin support 100 which includes leveling link support areas 101 and 102, each having a threaded linkage pin attachment hole 103 and a linkage pin insertion hole 104. The removable linkage pin support 100 also includes a tilt cylinder support area 105 having a threaded linkage pin attachment hole 106 and linkage pin insertion holes 107. Included in each leveling link support area are access holes 108 for assembling the linkage pin 111 to the tilt cylinder support area 105. In practice, the linkage pin 111 is assembled to the tilt cylinder support area 105 by inserting it into the insertion holes 107 via one of the access holes 108. Also included are attachment holes 109a and 109b for rigidly attaching the removable linkage pin support 100 to the front frame 20 via screws 130a and 130b respectively. Finally, a hydraulics access hole 108a is provided for supplying hydraulics to the hydraulic tilt cylinder 81 via hydraulic tubes or pipes (not shown). Linkage pins 110 and 111 are assembled as shown in FIG. 4 after the first ends of the leveling links 82a and 82b and the hydraulic tilt cylinder 81 are in place for mounting to the removable linkage pin support 100.

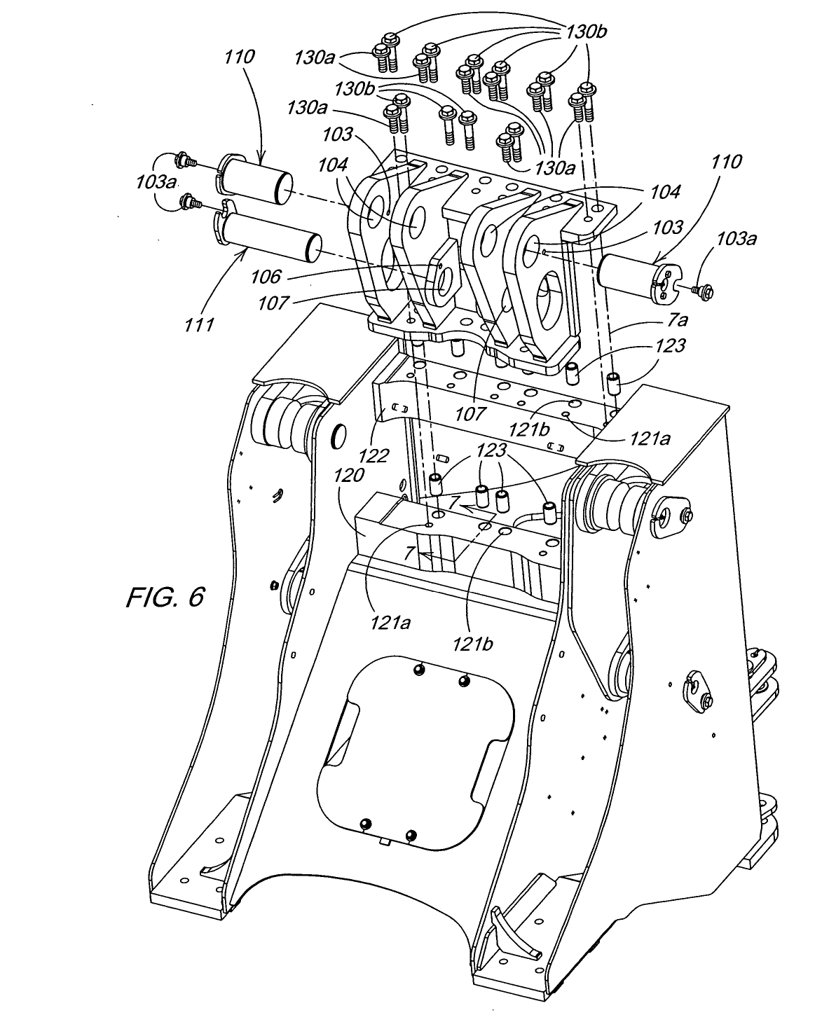

FIG. 6 is a detailed view of the load bearing areas 120 and 122. In this particular configuration, the load bearing areas 120 and 122 contain threaded attachment holes 121a and 121b for rigidly attaching the removable linkage pin support 100 to the load bearing areas 120 and 122. The attachment holes 121a and 121b are configured in a pattern that matches that of attachment holes 109a and 109b. Each of the attachment holes 121b includes a countersunk portion 121b′ and a threaded portion 121b″ for receiving the attachment bolts 130b. The threaded portions 121b″ are smaller than, parallel to, and concentric with the countersunk portions 121b′. The countersunk portions 121b′ have diameters equal to those of the attachment holes 109b and are sized to fit the outer diameter of locator bushings 123. The inner diameters of the locator bushings 123 are sized to fit the outside diameter of the shanks or threaded areas, i.e. the inserted portion, of the bolts 130b.

In practice, the locator bushings 123 are placed in the countersunk portions 121b′ and the linkage pin support 100 is assembled to the front frame 20 by placing the matching attachment holes 109b directly over the exposed areas of the locator bushings 123 and pressing the linkage pin support 100 down. The linkage pin support 100 is then rigidly attached to the front frame 20 via bolts 130a and 130b.

Having described the illustrated embodiment, it will become apparent that various modifications can be made without departing from the scope of the invention as defined in the accompanying claims.

1. A linkage support system for a work vehicle, the work vehicle including a frame, a work tool, and a linkage for manipulating the work tool, the frame having a left mast portion and a right mast portion, the linkage support system comprising:
a load bearing support, the load bearing support being a portion of the frame located between the left mast portion and the right mast portion; and
a linkage pin support, the linkage pin support removably attached to the load bearing support, the linkage coupled to the linkage pin support.

2. The linkage support system of claim 1, further comprising a reinforced area of the frame wherein the load bearing support is the reinforced area.

3. The linkage support system of claim 1, wherein the load bearing support and the linkage pin support are removably attached by screws.

4. The linkage support system of claim 1, wherein the linkage pin support comprises an integrated linkage pin support.

5. The linkage support system of claim 4, wherein the integrated linkage pin support comprises at least two metal parts, the at least two metal parts being welded together.

6. The linkage support system of claim 4, wherein the integrated linkage pin support comprises a single metal casting.

7. The linkage support system of claim 1, further comprising a boom, the boom comprising:
a left boom portion having a first left boom end and a second left boom end;
a right boom portion having a first right boom end and a second right boom end; and
a cross tube, the first left boom end and the first right boom end respectively and pivotally connected to the left mast portion and the right mast portion, the second left boom end and the second right boom end pivotally connected to the work tool, the cross tube rigidly connecting the left boom portion and the right boom portion.

8. The linkage support system of claim 1, further comprising a linkage pin, wherein the linkage pin support has an access hole and an insertion hole, the linkage pin being assembled to the linkage pin support by transporting the linkage pin through the access hole and inserting the linkage pin into the insertion hole.

9. A linkage support system for a work vehicle, the work vehicle including a frame, ground engaging means for supporting and propelling the frame over a surface, a mast, the mast forming a portion of the frame and extending upwardly from another portion of the frame, a boom having a first boom end and a second boom end, the first boom end being pivotally coupled to the mast, a work tool operatively coupled to the second boom end, and a linkage for manipulating the work tool, the linkage support system comprising:
a load bearing support located on the mast; and
a linkage pin support, the linkage pin support being removably attached to the load bearing support, the linkage being coupled to the linkage pin support.

10. The linkage support system of claim 9, wherein the linkage includes a first linkage end and a second linkage end, the first linkage end being coupled to the linkage pin support, the second linkage end being coupled to the work tool.

11. The linkage support system of claim 9, wherein the linkage includes a power tilt device, the power tilt device being coupled to the linkage pin support, the power tilt device powering the linkage.

12. The linkage support system of claim 11, wherein the power tilt device comprises a hydraulic tilt cylinder.

13. The linkage support system of claim 9, wherein the frame comprises the load bearing support.

14. The linkage support system of claim 9, further comprising a linkage pin, wherein the linkage pin support has an access hole and an insertion hole, the linkage pin being assembled to the linkage pin support by transporting the linkage pin through the access hole and inserting the linkage pin into the insertion hole.

15. The linkage support system of claim 12, wherein the linkage pin support includes a hydraulics access hole for supplying hydraulics to the hydraulic tilt cylinder.

16. A work vehicle for performing a work operation, the work vehicle comprising:
a frame;
ground engaging means for supporting and propelling the frame;
a mast extending upwardly from the frame;
a boom having a first boom end and a second boom end, the first boom end pivotally coupled to the mast;
a work tool operatively coupled to the second boom end;
a linkage for manipulating the work tool, the linkage having a first linkage end and a second linkage end;
a load bearing support located on the mast; and
a linkage pin support, the linkage pin support removably attached to the load bearing support, the first linkage end being coupled to the linkage pin support, the second linkage end being coupled to the work tool.

17. The work vehicle of claim 16, further comprising a linkage pin, wherein the linkage pin support has an access hole and an insertion hole, the linkage pin being assembled to the linkage pin support by transporting the linkage pin through the access hole and inserting the linkage pin into the insertion hole.

18. The work vehicle of claim 16, wherein the linkage pin support is an integrated linkage pin support.

19. The work vehicle of claim 16, wherein the linkage comprises:
a power tilt device; and
a bell crank, the power tilt device having a first tilt device end and a second tilt device end, the first tilt device end being pivotally coupled to the linkage pin support, the second tilt device end being operatively coupled to the bell crank.

20. The work vehicle of claim 19, wherein the power tilt device comprises a hydraulic tilt cylinder.

21. The work vehicle of claim 20, wherein the linkage pin support includes a hydraulics access hole for supplying hydraulics to the hydraulic tilt cylinder.

22. A method of manufacturing a linkage support system for a work vehicle, the work vehicle including a frame, ground engaging means for supporting and propelling the frame over a surface, a mast extending upwardly from the frame, a boom having a first boom end and a second boom end, the first boom end being pivotally coupled to the mast, a work tool operatively coupled to the second boom end, and a linkage for manipulating the work tool, the linkage having a first linkage end and a second linkage end, the method comprising:
manufacturing a linkage pin support independently and separately from the frame;
using a portion of the mast as a load bearing support; and
removably attaching the linkage pin support to the load bearing support.

23. The method of claim 22, wherein the linkage pin support system includes a linkage pin and wherein the linkage pin support has an access hole and an insertion hole, the linkage pin being assembled to the linkage pin support by transporting the linkage pin through the access hole and inserting the linkage pin into the insertion hole.

24. The method of claim 22, wherein the first linkage end is coupled to the integrated linkage pin support and the second linkage end is coupled to the work tool.

25. The method of claim 24, wherein the linkage comprises a power tilt device and a bell crank, the power tilt device having a first tilt device end and a second tilt device end, the first tilt device end being coupled to the integrated linkage pin support, the second tilt device end being coupled to the bell crank.

26. The method of claim 25, wherein the power tilt device is a hydraulic tilt cylinder.

27. The method of claim 26, wherein the linkage pin support includes a hydraulics access hole for supplying hydraulics to the hydraulic tilt cylinder.

28. A method of manufacturing a work vehicle, the work vehicle including a frame, ground engaging means for supporting and propelling the frame over a surface, a mast extending upwardly from the frame, a boom having a first boom end and a second boom end, the first boom end being pivotally coupled to the mast, a work tool operatively coupled to the second boom end, and a linkage for manipulating the work tool, the linkage having a first linkage end and a second linkage end, the method comprising:
manufacturing a linkage pin support independently and separately from the frame;
using a portion of the mast as a load bearing support;
removably attaching the linkage pin support to the load bearing support;
coupling the first linkage end to the linkage pin support; and
coupling the work tool to the second linkage end.

29. The method of claim 28, wherein the work vehicle includes a linkage pin and the linkage pin support includes an access hole and an insertion hole, the linkage pin being assembled to the linkage pin support by transporting the linkage pin through the access hole and inserting the linkage pin into the insertion hole.

30. The method of claim 28, wherein the mast comprises:
a left mast portion; and
a right mast portion, the load bearing support being located between the left mast portion and the right mast portion.

31. The method of claim 28, wherein the linkage comprises:
a hydraulic tilt cylinder, the hydraulic tilt cylinder having a first tilt cylinder end and a second tilt cylinder end; and
a bell crank, the first tilt cylinder end being coupled to the linkage pin support, the second tilt cylinder end being coupled to the bell crank.

32. The method of claim 28, wherein the linkage pin support is an integrated linkage pin support.

33. The method of claim 31, wherein the linkage pin support includes a hydraulics access hole for supplying hydraulics to the hydraulic tilt cylinder.
